(19) United States
(12) Patent Application Publication
(10) Pub. No.: US 2009/0154738 A1
(43) Pub. Date: Jun. 18, 2009

(54) Mixable earphone-microphone device with sound attenuation

(76) Inventor: Ayan Pal, Brooklyn, NY (US)

Correspondence Address: Ayan Pal, 7H, 303 Beverley Rd, Brooklyn, NY, 11218, US

(21) Appl. No.: 12/316,817

(22) Filed: Dec. 17, 2008

Related U.S. Application Data
(60) Provisional application No. 61/008,176, filed on Dec. 18, 2007.

(51) Int. Cl. H04R 5/02; H04R 25/00

(52) U.S. Cl. 381/309; 381/384; 381/380; 381/375

(57) ABSTRACT

A portable device that provides sound level attenuation while also providing an acoustic representation of the user's sound environment using microphones attached to, or embedded in, the device, and providing the ability to blend in a user adjustable auxiliary audio source with the user's sound environment signal, whereby placement of the sound signal from both the microphones and the auxiliary input can be adjusted in the stereo field using stereo width and panning controls.

This application claims the benefit of U.S. Provisional Application No. 61/008,176, filed Dec. 18, 2007.

### BACKGROUND OF THE INVENTION

The sensitivity of the human ear is may be reduced, and the organ itself may be damaged by exposure to high levels of sound, including exposure to high amplitude bursts, and exposure to long-term high levels of sound. Several devices geared toward protecting the ear and its sensitivity from short-term and long-term exposure to high levels of sound have been developed that are well known to one of ordinary skill in the art. Their use varies widely, including, for example, but not limited to, sound attenuation while playing loud musical instruments. For example, playing drums is loud and generally requires some sort of sound attenuation device to achieve comfortable volume levels. The attenuation device is usually either ear plugs or construction style earmuffs (ie. Peltor brand earmuffs).

An example of such as device is described in U.S. Pat. No. 6,353,938, hereby incorporated by reference, in which an earmuff for hearing protection of the ear of a wearer is described, which includes an outer cup of rigid plastic material, whereby an inner cup of foam material is supported by the outer cup, and a cushion is attached to the outer cup for lying around the ear of the wearer. In this specific example, the outer cup of rigid plastic material includes a filler of metal powder such as carbonyl iron powder.

While a sound attenuation device does provide an adequate amount of audio level reduction, it also alters the sound quality of natural environment significantly, making the perceived sound muddy and muffled. Also, it is difficult to monitor external audio sources (for example, a metronome, compact disk, or radio) while wearing hearing protection. In addition to requiring ear protection in a noisy environment, however, a user may prefer to have or maintain the ability to perceive, distinguish, and understand certain sounds, such as language, conversation, warning sirens or other communicative sounds.

To address this situation, various devices have utilized signal processing techniques in attempts to suppress unwanted noise while still allowing the user to hear desired sounds. These techniques have included low pass filtering or a combination of low and high pass filtering, as well as attenuation of large amplitude audio signals. However, these techniques often attenuate or filter out frequencies important to the communication desired to be heard. In addition, devices that clip or reject some frequencies of the human voice can distort sound quality, and the result can be acoustically unpleasant and interfere with understanding.

Devices that include microphones that allow the user to perceive the natural audio environment have been developed and described. For example, U.S. Pat. No. 3,952,158, hereby incorporated by reference, described a headphone/earmuff device comprising a headband, a pair of ear cups, a speaker within each ear cup, and an associated positioning device attaching each ear cup to the headband that allows the user to adjust the fit of the device on his or her head. In the device described therein, each ear cup positioning device has a cylinder attached to either the ear cup or the headband, and a piston received slidably within the cylinder and attached to the other of the headband or the ear cup.

A device that combines loudspeakers and microphones is described in U.S. Pat. No. 4,088,849, hereby incorporated by reference, wherein the device combines a headphone having a pair of microphone-loudspeaker units interconnected by a clamping strap for holding the units against the ears of a wearer. An enclosure acoustically isolates the loudspeaker and microphone of each unit from each other. The microphone is mounted on the flat surface with its main direction of acoustic sensitivity oriented to a dummy earlap to receive a sound wave reflected therefrom.

U.S. Pat. Nos. 3,952,158 and 5,550,923, hereby incorporated by reference, disclose devices for the protection of the ears from loud sounds while enabling low-level voice frequency sounds to be discerned. In both devices, a microphone is positioned on the outside of an insulated ear protector and a sound reproducer positioned within the protector. The sound picked up by the microphone is subjected to audio amplitude compression and voice frequency bandpass filtering before being converted back to sound.

Blending/mixing adjustable audio sources with the natural audio environment signal in the frame work of a sound attenuating head set is achievable in recording studios, but in none of the above devices, is the ability to blend in an auxiliary audio signal into the speakers combined with controlled reproduction of the sound picked up by the microphones within a device. Furthermore, none of the previously disclosed devices provide stereo width or panning controls for controlling the stereo image perceived by the used, which allows the user better to distinguish and identify the sounds from the microphones and the auxiliary inputs.

### BRIEF SUMMARY OF THE INVENTION

A portable device that provides sound level attenuation while also providing an acoustic representation of the user's sound environment using microphones attached to, or embedded in, the device, and providing the ability to blend in a user adjustable auxiliary audio source with the user's sound environment signal, whereby placement of the sound signal from both the microphones and the auxiliary input can be adjusted in the stereo field using stereo width and panning controls. Controlling and/or adjusting stereo width and panning allows the user to place the incoming audio signals anywhere in the stereo field, which facilitates identification and differentiation of each signal when listening to both signals concurrently. The device can be used as an aid while practicing a musical instrument, with or without pre-recorded audio or metronome whereby the user can place each signal in an easily identifiable position in the stereo field by using and/or adjusting the stereo width and panning controls; as a personal monitoring system in a recording studio; to listen to pre-recorded audio in a noisy environment, such as the subway, at reasonable levels, while still being able to listen to the external audio environment; or to boost the audio level of the natural environment, for example by hearing impaired users.

### BRIEF DESCRIPTION OF THE DRAWINGS

FIG. 1. Illustration of an earmuff-style device with each of the following components: (1) earmuff shell, whereby (a) is the frontal view of the left earmuff, and (1b) is the cross-section view of the right earmuff; (2) microphone, whereby (2a) depicts the external view and 2b. internal cross section of the microphone; (3) earmuff foam padding; (4) connecting wires, whereby (4a) depicts the connecting wire from one earmuff to mixer connection, (4b) depicts internal wiring of the speaker to mixer connection, and (4c) depicts internal wiring of the microphone to mixer connection; (5) depicts a speaker in cross-section; (6) depicts a wire connecting earmuffs to mixer; (7) depicts a microphone amplifier gain control; (8) depicts a stereo width control; (9) depicts a panning control; (10) depicts an auxiliary line in level control; (11) depicts the auxiliary line input jack; (12) depicts microphone output signal; (13) depicts a power supply and (14) depicts an earmuff to mixer connection.

FIG. 2. Stereo Field Placement Examples.

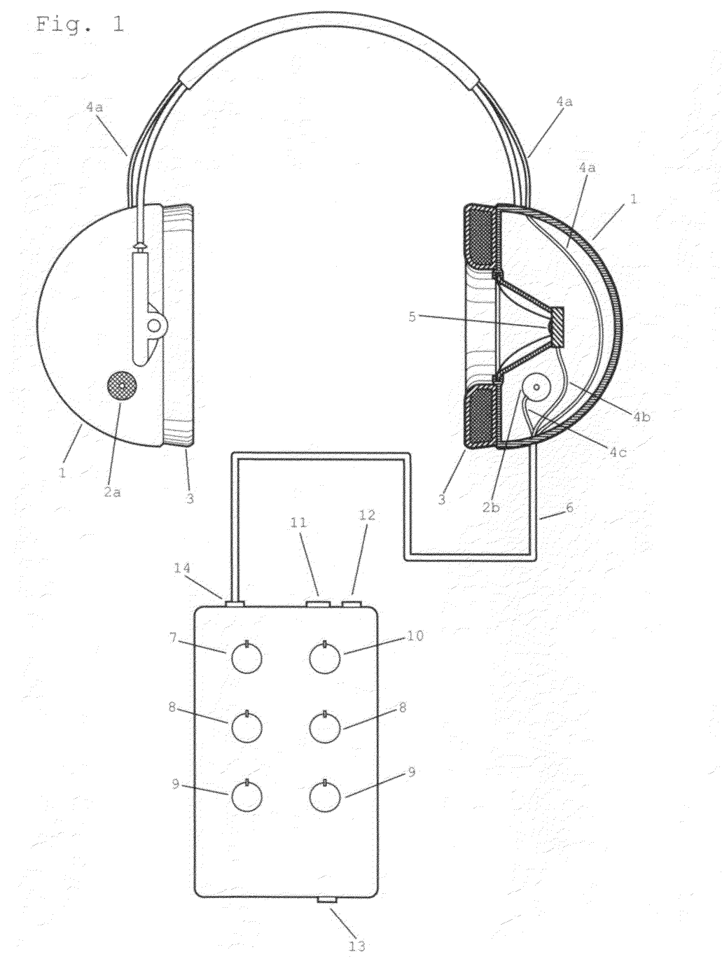

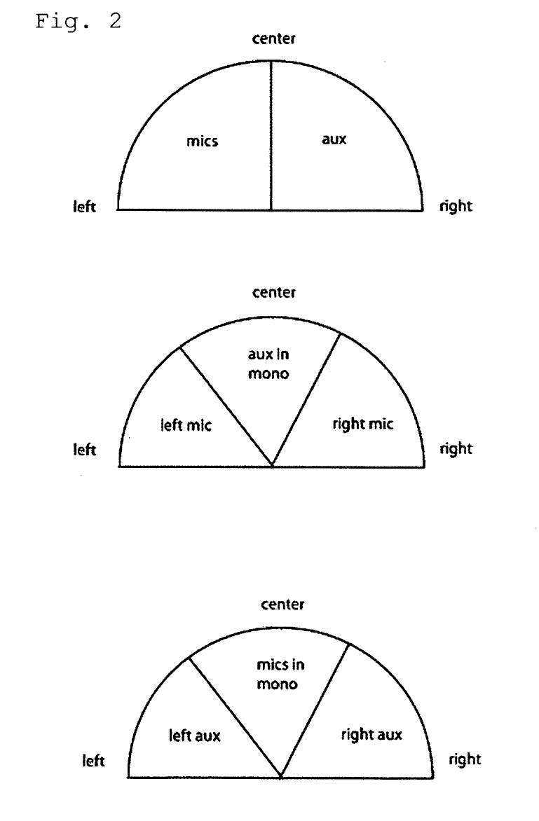

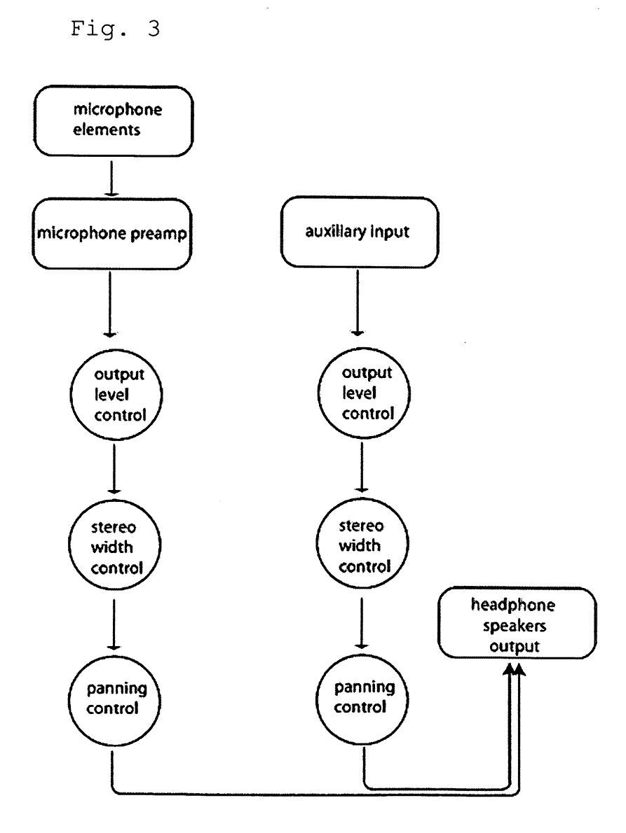

A. Microphones and auxiliary (“aux”) input stereo width control are set to normal stereo. The microphone's panning control is set to Left, and the Aux input control is set to Right.
B. The microphone's stereo width control is set to Wide, which eliminates the center image. The Aux input is set to mono. This places the aux input in the dead center of the stereo field, and the microphones are present only in the left and right ear, with nothing in the center.
C. The aux input's stereo width control is set to Wide, which eliminates the center image. The microphone input is set to mono. This places the microphone input in the dead center of the stereo field, and the aux signal is present only in the left and right ear, with nothing in the center.

FIG. 3. Block diagram of the signal flow of the device of the invention.

### DESCRIPTION OF THE INVENTION

The device of the invention provides the user sound attenuation, controlled reproduction of sound picked up by microphones embedded within the device, and the ability to blend an auxiliary audio signal into the output of the embedded speakers. Each input in the system (microphones and auxiliary input) has 3 distinct controls: level, stereo width, and panning.
1. The level setting controls how loudly the signal is amplified in the speakers. At the lowest setting, the signal is completely off and no signal will be sent to the speakers. At the highest setting the signal is amplified at full volume.
2. The stereo width control determines the stereo image that is produced for the user. When the control is in its center position, the left channel of the input signal is amplified only in the left speaker, and the right channel of the input signal is amplified only in the right speaker. When the control is set to its right most position, the stereo image is in mono, meaning the left channel of the input signal is routed equally to the left and right speakers, and the right channel of the input signal is routed equally to the left and right speakers. When the width control is set to its left most position, the center of the stereo image is canceled out. This is achieved by inverting the phase of the left channel input signal, which causes it to be 180 degrees out of phase with the right input channel. Any sound that the left and right inputs have in common is phased out and becomes inaudible. The only signals that is amplified are those that are unique to the left and right inputs.
3. The panning control determines how much signal is amplified to the left and right speakers. When the control is set to its left most position, the input signal is only sent to the left speaker. When the control is set to its center position, the input signal is sent to the left and right speakers equally. When the control is set to the right most position, the input signal is sent only to the right speaker.

The device of the present invention uses two microphone elements embedded in the sound attenuation component, which are connected to a microphone preamplifier, and then the microphone signal is provided user adjustable level, stereo width, and panning controls. This microphone signal is then routed to a pair of speakers embedded inside the sound attenuation component of the device. In addition, the product of the invention comprises an auxiliary stereo audio input which has its own adjustable level, stereo width and panning controls, which is also fed into the pair of speakers inside the hearing protectors. Thereby, the person wearing the device of the invention has the ability to listen to the natural outside sound environment, but with a level control, while also allowing the user perceive pre-recorded audio signal simultaneously through the auxiliary input, and mix the levels of the natural environment and pre-recorded material to users personal preference.

Stereo width and panning controls allow the user to place the incoming audio signals anywhere in the stereo field. As described above, this allows for easier identification and differentiation of each signal when listening to both signals concurrently.

Combining a sound attenuation component with microphones, and an auxiliary input, each with adjustable output levels, stereo width and panning controls, and speakers in one device enables the use of sound equipment to users of the invention for many purposes, including such practical applications as:
Practice a musical instrument, like drums, at an attenuated volume level, while maintaining clear audio fidelity.
Practice music instrument along with pre-recorded audio or metronome, and use stereo width and panning controls to place each signal in an easily identifiable position in the stereo field.
Use as personal monitoring system in a recording studio.
Use to listen to pre-recorded audio in a noisy environment, such as the subway, at reasonable levels, while still being able to listen to the external audio environment.
For hearing impaired individuals, can use to boost the audio level of the natural environment

The device can be constructed in any of the styles that meet the requirements of the device of the instant invention, and that would be known to an artisan of ordinary skill in the art—principally in the earmuff or in-ear styles.

The earmuff style is constructed by creating a shell structure that has any a means of affixing a microphone, including, but not limited to, a hole in each earmuff (left and right ear muff), preferably in the center, facing forward, into which the microphone by placed. The methods of creating the hole include, but are not limited to, drilling, or hole can be part of the fabrication of the original earmuff structure. The hole is matched in size to the embedded microphone, and may be, for example, but not limited to, ⅜ inches in diameter. The microphone capsule is inserted into each hole and secured. The speaker device is embedded inside the earmuff. Both the speaker devices and microphones are connected to the mixer, either by cables or by a wireless connection. The microphones are affixed or mounted temporarily, semi-permanently, or permanently by any methods known to one of ordinary skill in the art. For example, the microphone may be semi-permanently or permanently attached by use of materials that affix the microphone to the earmuffs, such as, for example, but not limited to rubber cement, glue, tape, or any other material. Alternatively, the microphone and/or the microphone capsule may be attached temporarily or semi-permanently to render it removable or swappable, which would allow switching capsules with different pick-up patterns (for example, but not limited to, switching between cardiod vs omni-style pick-up patterns), by any method known to one of ordinary skill in the art, such as, for example, by embedding the microphone capsules in a bushing that is threaded on the outside, which screws into a tapped hole on the earmuff.

The in-ear device is constructed by embedding a speaker inside an earplug device, such as, for example, as in most hearing aid devices. The microphone is affixed to the outside of the earplug, facing forward, also such as, but not limited to, as in common hearing aid devices. The wires are preferably connected internally. As in the above earmuff style device, both the speaker devices and microphones are connected to the mixer, either by cables or by a wireless connection. As described above, the microphones are affixed or mounted temporarily, semi-permanently, or permanently by any methods known to one of ordinary skill in the art. For example, the microphone may be semi-permanently or permanently attached by use of materials that affix the microphone to the earmuffs, such as, for example, but not limited to rubber cement, glue, tape, or any other material. Alternatively, the microphone and/or the microphone capsule may be attached temporarily or semi-permanently to render it removable or swappable, which would allow switching capsules with different pick-up patterns (for example, but not limited to, switching between cardiod vs omni-style pick-up patterns), by any method known to one of ordinary skill in the art.

In each case, the device consists of the following elements, each as described in detail below:
1. At least one, preferably two sound attenuation components (e.g. one for each ear)
2. Two or more attached or embedded microphones
3. Two or more attached or embedded loud speakers
4. At least one external auxiliary input jack or connector
5. Microphone, speaker, and auxiliary input connections to a sound mixer
6. Sound mixer
7. Microphone amplifier
8. Power supply

Any sound attenuating component that reduces the amplitude of the sound waves of the user's sound environment entering the ear may be incorporated in the device of the instant invention. The device can be either worn over the ear or inside the ear. The sound attenuating components may be protective ear muffs, earpieces, a hood or other ear protective device which at least partially isolates a user from not helpful, bothersome, undesirable, or damaging sound levels. Preferably the sound attenuating component provides a high degree of sound isolation, such as between 20 to 30 dB, depending on the use of the device; however, it shall be understood that any degree of isolation, may be appropriate, or even preferable, depending on the use/application of the device.

The over the ear device is of the earmuff style, which is usually a plastic shell with foam lining that fits over the ear and connect with a headband, as described in detail in U.S. Pat. No. 5,241,971, incorporated herein by reference. The in-ear variety can be either molded rubber or foam that is inserted into the ear canal.

In one embodiment, an ear-protection cup for ear muffs or headphones is used, comprising a cup-shaped frame and a resilient sealing member located at the peripheral edge thereof, by means of which the ear-protection cup can be brought into abutment with an annular shaped part of a user's head located around the ear. The frame is composed of a rigid, cup-shaped outer shell and an inner wall spaced from the outer shell and extending for a substantial way between the inner parts of the outer shell to which it is rigidly connected. The inner wall thus defines between itself and the outer shell an intermediate space in which a layer of elastomeric material is arranged compressed between the outer shell and the inner wall. In another embodiment, the sound attenuation component is the casing of an in-ear, “earbud-style” headphone that seals the ear canal, and reduces the amplitude of natural sound waves entering the middle and inner ear.

Any microphone that can be attached to, or embedded in, the device may be incorporated in the device. Alternatively, the microphones may be external and attached to the device as described below. For example, omni capsules microphones, preferably a small omni capsule, such as, for example, but not limited to, as used in hearing devices may be used and/or embedded. In one exemplary embodiment, an electret microphone in which an electret diaphragm, a back electrode plate disposed opposite thereto and a tubular back electrode holder for holding the back electrode plate are housed in a capsule, an impedance conversion element is housed in a hole made in the peripheral wall of the back electrode holder, and an input terminal of the impedance conversion element is connected to the back electrode plate and an output terminal is led out of the capsule through a notch formed in its peripheral wall.

Various different microphone pickup patterns may be used, for example to pickup sound evenly from all directions and achieve realistic reproduction of the natural acoustic environment, by use of an omni-directional capsules, or to pick up sound only directly in front of the capsule by use of uni-directional cardiod or hyper-cardiod capsules, as described, for example, in U.S. Pat. No. 5,550,923, incorporated by reference herein. A preferred embodiment of the invention has an interchangeable microphone capsules so the user may insert different capsules for different situations.

Directional microphones greatly reduce much of the sound which may be present in the user's environment, as the user's sound environment often comprises sound that emanates from many directions at the same time. The degree of directionality of the microphone used is preferably adjustable so that sound not helpful, bothersome, or harmful to the user can be reduced, as a further means of adjustable sound attenuation, to a level that filters out sounds that is either not helpful, bothersome, or harmful to the user. Ideally, this additional sound attenuation is achieved by use of a directional microphone only to the extent helpful, protective, or necessary, thus allowing the user to hear a variety of sounds that may come from various directions.

The direction of said directional microphone is also preferably adjustable by the user, as described in U.S. Pat. No. 5,550,923, incorporated by reference herein, so that, as a non-limiting example, the directional microphone can be pointed in the direction faced by the user toward a person with whom they are conversing. The user's ability to adjust the direction in which the directional microphone is pointed allows the user to adapt the device of the instant invention to the nature of his or her conditions, which may change between uses, or prior to, subsequent to, or during use of the device

Any sound reproduction component that is structurally and functionally compatible with the device of the present invention may be used in the device of the present invention. The sound reproduction component can be either an external speaker, or an in-ear speaker, as described above. A speaker for an earmuff-style device must fit the dimensions of the earmuff-style sound attenuation component, and is preferably smaller than 2 inches, typically 1 inch in diameter. A sound reproduction component for an in-ear-style device must fit the dimensions of the in-ear-style sound attenuation component, and is generally referred to as an earbud style headphone.

Any external auxiliary input component that can provide external auxiliary sound input to another device may be used in the device of the present invention. The external auxiliary input component may be connected to the device by any means known to one of ordinary skill in the art. As non-limiting examples, the external auxiliary input may be connected to the device by means of 2 individual ¼ inch tip-sleeve connectors—one for the left input channel, one for the right input channel; by means of 2 individual ⅛ inch tip-sleeve connectors—one for the left input channel, one for the right input channel; by means of two individual RCA style connectors—one for the left input channel, one for the right input channel; by means of two 1⅛ inch tip-ring-sleeve connectors—one for the left input channel, one for the right input channel; or by means of a built-in Ipod insertion slot.

Microphones, sound reproduction components, and external auxiliary input connectors or jacks may be connected to the sound mixer by any means known to one of ordinary skill in the art. As non-limiting examples, the microphone(s) may be connected to the sound mixer by means of a ⅛ inch tip-ring-sleeve connector or by means of a ¼ inch tip-ring-sleeve connector, which will send both the left and right microphone signal to the mixer, whereby both mics would share a common ground on the sleeve; by means of two individual ⅛ inch tip-sleeve connector—one per microphone—or by means of two individual ⅛ inch tip-ring-sleeve connectors—one per microphone, whereby a balanced signal would be sent; by means of two individual ⅛ inch tip-sleeve connectors—one per microphone; by means of two individual male XLR connectors—one per microphone; or by means of a wireless transmitter of any kind known to one of ordinary skill in the art. The sound reproduction components are connected by any means known to one of ordinary skill in the art, such as, for example, but not limited to, a ⅛ inch tip-ring-sleeve connector, a ¼ inch tip-ring-sleeve connector, or a wireless transmitter The auxiliary input component may be connected to the device by any means known to one ordinary skill in the art, such as, for example, but not limited to, by means of two individual ¼ inch tip-sleeve connectors—one for the left input channel, one for the right input channel; by means of two individual ⅛ inch tip-sleeve connectors—one for the left input channel, one for the right input channel; by means of two individual RCA style connectors—one for the left input channel, one for the right input channel, by means of 1⅛ inch tip-ring-sleeve connectors; by means of 1¼ inch tip-ring-sleeve connectors; or by means of an Ipod insertion slot; by means of a wireless transmitter.

As a further non-limiting example, the microphone and sound reproduction component connection can be combined to use one single 8 Position 8 Contact (8P8C) jack, often also referred to as an RJ45 or ethernet jack.

Any sound mixing component known to an artisan of ordinary skill in the art that meets the requirements of the device of the instant invention may be used. The sound mixer component must have an input connection for the, or each of the microphones and for the external auxiliary input, each connected as described above, and outputs for each of the sound reproduction components. As non-limiting examples, it may be constructed with jacks, such as TRS jacks, preferably ⅛″ TRS jacks, or one or more Ethernet jacks, for example, but not limited to, one for each speaker/microphone assembly. The input jacks are connected, preferably internally, to the circuit that controls the level, stereo width, and panning. The level, stereo width, and panning controls are controlled in the circuit with potentiometers.

Any controls on the sound mixing component known to one of ordinary skill in the art may be used. As non-limiting examples, the individual controls may be variable resistor potentiometers whereby on the surface of the sound mixing component they may be knobs or sliders

Any microphone preamplifying component, on its own or as a component of the sound mixer or of the microphone, that sends power to the microphone capsules, preferably with variable gain control, and that activates the microphones and enables them to capture and send an audio signal, may be used as a component of the device of the instant invention.

Any power supply component known to an artisan or ordinary skill in the art that meets the requirements of the device of the instant invention may be used. As non-limiting examples, the circuit may be powered by one or more batteries, such as, for example, but not limited to, a 9V battery, or by an external power source. An external power source may be used by use of an adapter, which contains an AC to DC transformer, utilizing a more generally available source of electric supply, and converting the electric current, such as, for example, but not limited to, 220 or 110Volt Alternating Current (AC), to a voltage more applicable in a device of the current invention, such as, for example, but not limited to, 9V Direct Current (DC).

The device of the instant invention may further include and equalizer or other sound modifying filters, for example, but not limited to, adaptive filters, for example, but not limited to, having independently controlled low- and high-pass filters, as described in U.S. Pat. No. 5,550,923, incorporated by reference herein.

A device with an earmuff-style sound attenuator may be preferred and/or chosen by the user, based on personal preference, and based on the situation in which the device is being used. As non-limiting examples, certain users may prefer an earmuff-style device because it covers the whole ear, which is inserted inside the ear (fit and comfort of the device); certain users may prefer the sound quality of the sound reproduction components of the earmuff-style device which are mounted externally from the ear, and are larger components in diameter; and certain users may prefer the sound attenuation quality provided by the earmuff, as opposed to the in-ear style earplug.

A device with an in-ear-style sound attenuator may be preferred and/or chosen by the user, based on personal preference, and based on the situation in which the device is being used. As non-limiting examples, certain users may prefer use of an in-ear-style device because it is inserted inside the ear, and is smaller and weighs less (fit and comfort of the device); certain users may prefer the sound quality of the in-ear earpiece which mount the speakers internally to the ear; certain users may prefer the sound attenuation quality provided by the in-ear earpiece; certain users may prefer the greater mobility of the in-ear earpiece, which is smaller and more light weight than the earmuffs, making it for easier for use in transit, e.g. when the preferred use is while walking or riding private or public transportation (cars, trains, busses, airplanes, subways, etc.); certain users may prefer the in-ear-style device because it packs into a smaller volume when not in use; and certain users may prefer the in-ear-style device because of the discretion provided by the appearance of the unit due to its smaller size and lesser visibility.

A device with an external sound mixing component would be chosen by the user, based on personal preference, and based on the situation in which the device is being used. As non-limiting examples, users may prefer a device with an external sound mixing component in a recording studio/practice environment, where the precision provided by the larger knobs of the mixing unit is preferred, where the ease of use is increased by the ability to position the mixing unit in an easily accessible position, within arms reach and visual line of sight, or where a recording engineer may choose to capture the microphone line out signal from the user's headphone. An external sound mixing component may also be preferable in a device that uses a wall electrical outlet as its power source, thus not having to utilize a battery power source. Furthermore, an external sound mixing component may also be preferable in a device that facilitates utilization of a built-in Ipod insertion slot or metronome.

A device with an internal sound mixing component would be chosen by the user, based on personal preference, and based on the situation in which the device is being used. As non-limiting examples, users may prefer a device with an internal sound mixing component because most of the device, or the entire device may be self enclosed with fewer or no external components (the whole device may be on the head of the user), and hence because of the greater ease of use and mobility of the device, which, for example, provides easier use in transit, e.g. when the preferred use is while walking or riding private or public transportation (cars, trains, busses, airplanes, subways, etc.); or certain users may prefer a device with an internal sound mixing component because it is has fewer tangible components (reduced clutter), and is more easily/readily packed and/or stored when not in use.

Preferred embodiments, depending on the use, as described above, include earmuff-style devices with external mixing units, in-ear-style devices with external microphones sound mixing components, and earmuff-style devices with internal sound mixing components, preferably with control knobs mounted on the earmuffs.

It may be useful, helpful, or desirable for a professional, such as, for example, a qualified sound engineer or an industrial hygienist, to adjust to the device of instant invention to guard the user against accidental injury stemming from use of the device, or occurring in spite of use of the device of the present invention.

### Example 1

The device of Example 1 was constructed using the following parts:

Peltor brand hearing protector ear muffs

2 Radioshack Electret Microphone Element with Leads, Model: 270-092

1 set Generic headphones, 1 inch diameter speakers, ⅛″ trs connector

Velleman MK136 Super Stereo Ear kit

Rolls MX28 Stereo MINI-MIX VI mixer

1 digital metronome (not part of the invention, acts as auxiliary audio source)

2 Hosa CMP153 Y Cable ⅛ Inch TRS to Dual ¼ Inch TS Cable 3 Foot

A 2⅜″ diameter hole was drilled into each earmuff. A microphone capsule was embedded in each hole, and secured adhesive tape. Connection wire was soldered to the leads of each microphone capsule and then soldered directly to the leads of the Velleman MK136 Super Stereo Ear. The headphone speakers were embedded into the inside of the earmuffs using pressure alone. The Velleman MK136 Super Stereo Ear was enclosed in a 2″×3″×4″ metallic project box.

The headphone output from the Velleman MK136 Super Stereo Ear was connected to input 1 of the Rolls MX28 Stereo MINI-MIX VI mixer using a Hosa CMP153 Y Cable ⅛ Inch TRS to Dual ¼ Inch TS Cable. The output from the digital metronome was connected to input 2 of the Rolls MX28 Stereo MINI-MIX VI mixer using a Hosa CMP153 Y Cable ⅛ Inch TRS to Dual ¼ Inch TS Cable. The headphones were connected to the headphone output of the Rolls MX28 Stereo MINI-MIX VI.

1. A portable device comprising at least one sound attenuation component, two microphones, an auxiliary input, and two sound reproduction components, whereby the microphone picks up the sound environment of the device's user, signal from the microphones and the auxiliary sound input can be mixed into the devices sound output, and placement of the signal of both the microphones and the auxiliary input can be adjusted in the stereo field using stereo width and panning controls.

2. The device of claim 1, wherein the device comprises a sound attenuation component that is a hood.

3. The device of claim 1, wherein the device comprises at least two sound attenuation components that are ear muffs.

4. The device of claim 1, wherein the device comprises at least two sound attenuation components that are the casings of in-ear headphones.

5. The device of claim 1, wherein the microphone of the device is omni-directional.

6. The device of claim 1, wherein the microphone of the device is a uni-directional cardiod or hyper-cardiod capsule.

7. The device of claim 1, wherein the external auxiliary input component is connected to the device by means of at least one connector selected from the group consisting of, 1⅛ inch tip—ring-sleeve connectors, ¼ inch tip-sleeve connectors, ⅛ inch tip-sleeve connectors, RCA style connectors, and a built-in Ipod insertion slot.

8. The device of claim 1, wherein the microphones, sound reproduction components, and external auxiliary input connectors are connected to the sound mixer by at least one connector selected from the group consisting of ⅛ inch tip-ring-sleeve connectors, ¼ inch tip-ring-sleeve connectors, ⅛ inch tip-sleeve connectors, ⅛ inch tip-ring-sleeve connectors, male XLR connectors, 8 Position 8 Contact (8P8C) jacks, RJ45 jacks, ethernet jacks, and wireless transmitters.

9. The device of claim 1 that comprises a microphone preamplifying component.

10. The device of claim 1 that comprises a powersupply component, which component either comprises one or more batteries, or derives power from an external power source.

11. The device of claim 1, wherein the device comprises at least two external microphones.

12. The device of claim 1, wherein the device comprises at least one internal sound mixing unit.

13. The device of claim 1, wherein the device comprises one or more sound modifying filters.

14. The device of claim 1, wherein the device comprises a sound mixer component that is external and connected to the device by a connector.

15. The device of claim 13, whereby the sound mixer component is constructed with connectors selected from the group consisting of TRS jacks, ⅛″ TRS jacks, Ethernet jacks, and wireless transmitters, and wherein the input jacks are connected to the circuit that controls the level, stereo width, and panning with potentiometers.

16. The device of claim 14, wherein the controls of the sound mixing component are variable resistor potentiometers regulated by knobs or sliders.

17. The device of claim 2, where the largest two of the at least two sound reproduction devices of the device are smaller than 2 inches in diameter.

18. The device of claim 2, where the largest two of the at least two sound reproduction devices of the device are smaller than 1 inches in diameter.

19. The device of claim 3, where the largest two of the at least two sound reproduction devices of the device are smaller than 2 inches in diameter.

20. The device of claim 3, where the largest two of the at least two sound reproduction devices of the device are smaller than 1 inches in diameter.
